(19) United States
(12) Patent Application Publication
(10) Pub. No.: US 2007/0086316 A1
(43) Pub. Date: Apr. 19, 2007

(54) Information recording/reproducing method and apparatus for same

(76) Inventors: Akemi Hirotsune, Saitama (JP); Masaki Mukoh, Tokyo (JP); Hiroyuki Minemura, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/366,591

(22) Filed: Mar. 3, 2006

(30) Foreign Application Priority Data
Oct. 17, 2005 (JP) 2005-301123

(51) Int. Cl. G11B 9/00; G11B 11/00

(52) U.S. Cl. 369/126; 369/13.01

(57) ABSTRACT

When external and internal environmental variation factors (characteristics of medium, variation in voltage, deterioration of medium and the like) occur, a reproduced signal is varied. In a learning system for reproduction of a voltage layer selection type multi-layer optical disk which making recording or reproducing by irradiation of energy, a level and/or pattern of an application voltage is adjusted in accordance with a reproduced signal at a predetermined position. Even if the reproduced signal, from the reflectivity down, is varied due to the external and internal environmental variation factors (characteristics of medium, variation in voltage, deterioration of medium and the like), the reproduced signal with the high quality can be obtained from the voltage layer selection type medium.

### INCORPORATION BY REFERENCE

The present application claims priority from Japanese application JP 2005-301123 filed on Oct. 17, 2005, the content of which is hereby incorporated by reference into this application.

### BACKGROUND OF THE INVENTION

The present invention relates to an information reproducing method and apparatus for reproducing information by light.

An optical disk is greatly characterized in that a recording medium (disk) can be detached from a recording/reproducing apparatus and the recording medium is inexpensive. Accordingly, it is desired that the optical disk apparatus attains high-speed operation and high-density mounting without losing the above characteristics.

In order to increase the effective recording density (effective surface density) of the optical disk, the multi-layer construction utilizing the features such as the long-range characteristic and the penetrability of light is desired. However, the optical disk having three or more layers has the trade-off relation of the penetrability and the recording sensitivity of each layer and must sacrifice any of the quality of reproduced signal and the recording sensitivity.

Accordingly, there has been developed the technique for solving the trade-off. JP-A-2003-346378 (corresponding to US2003/0218941), for example, discloses an optical disk including multiple recording layers using electrochromic material and a pair of electrodes between which the recording layers are held and a voltage is applied to change the absorption spectrum of the recording layers themselves so that light is absorbed to color a recording layer selectively so that information is recorded therein. Such a multi-layer optical disk of the system that a voltage is applied to change the characteristic of the layers so that a layer is selected is named a layer-selection type multi-layer optical disk. The above publication describes an example of the layer-selection type multi-layer optical disk.

JP-A-2002-82360 discloses light-writing type recording material having an electrochromic layer held between conductive layers. This publication does not concern multiple layers but concerns material.

### SUMMARY OF THE INVENTION

As a result of the Inventors' study, a conventional voltage layer selection type medium (super multi-layer medium) has been found to have problems that a reproduced signal, from the reflectivity down, is varied due to external and internal environmental variation factors (characteristics of medium, variation in voltage, deterioration of medium and the like) and the medium is apt to be deteriorated when a proper voltage is not applied. Further, when electrodes are constructed to be made bare, the electrodes are apt to be damaged and there is a possibility that the medium is broken when a voltage is applied in the damaged state of the electrodes.

It is an object of the present invention to solve the above problems by providing a reproducing method and apparatus capable of obtaining a reproduced signal with high quality upon reproducing and/or recording and in which a medium is not broken.

The configuration of the apparatus according to the present invention is now described concretely.

(1) Learning for reproduction is made before reproduction of user data from the voltage layer selection type multi-layer optical disk and an application voltage level and/or pattern is adjusted in accordance with a reproduced signal at a predetermined position, so that a satisfactory reproduced signal can be obtained. Detailed description thereof will be made in embodiments 1 to 4.

(2) Learning for recording is made before recording of user data in the voltage layer selection type multi-layer optical disk and an application voltage level and/or pattern is adjusted in accordance with reproduction result of a signal recorded at a predetermined position, so that a satisfactory signal can be recorded. Detailed description thereof will be made in embodiment 5.

(3) Learning for recording is made before reproduction of user data from the voltage layer selection type multi-layer optical disk and an application voltage level and/or pattern and a recording waveform and/or power are adjusted in accordance with reproduction result of a signal recorded at a predetermined position, so that a satisfactory signal can be recorded. Detailed description thereof will be made in the embodiment 5.

(4) The apparatus for making learning for reproduction before reproduction of user data from the voltage layer selection type multi-layer optical disk comprises means for applying a voltage in accordance with a reference pattern, means for inputting a reproduction signal for each application voltage, means for analyzing the relation of the application voltage and the reproduction signal to extract an evaluation value, means for calculating an optimum application voltage level and pattern on the basis of the extracted evaluation value and means for adjusting the application voltage level and/or pattern in accordance with the calculation result. Consequently, a satisfactory reproduction signal can be obtained. Detailed description thereof will be made in the embodiments 1 to 4.

Further, the reference pattern is preferably a plurality of voltage levels, so that accuracy of the learning for reproduction can be improved.

Moreover, the voltage of the reference pattern is preferably equal to or smaller than a voltage by which signal amplitude is not deteriorated even if the voltage is applied many times, so that it can be prevented by the learning for reproduction that the medium is deteriorated.

(5) The reproduction signal in the above items (1) to (3) preferably comprises any of signal amplitude, a reflectivity, jitter and an error rate. In the case of the signal amplitude, the learning for reproduction can be made regardless of the number of voltage applications to select a proper application voltage. Further, in the case of the reflectivity, the learning for reproduction can be made quickly. In the case of the jitter, the learning for reproduction and the learning for recording can be combined to shorten the time for preparation of recording and since the learning accuracy can be improved in the recording medium, the number of reproducible operations can be improved. Even if the reproduction state is just a little varied from its very satisfactory state, variation in level can be understood and accordingly a sign that the reproduction signal begins to be deteriorated can be detected. Further, in the case of the error rate, the learning for reproduction and the learning for recording can be combined to shorten the time for preparation of recording and since the learning accuracy can be improved in the recording medium, the number of reproducible operations can be improved. In addition, since the number of errors is counted to calculate the error rate, the state of deterioration can be grasped exactly even when the reproduction signal is deteriorated to some degree.

(6) The apparatus for making recording/reproducing before recording or reproducing of user data of the voltage layer selection type multi-layer optical disk comprises means for measuring a resistance between each pair of electrodes and means for judging on the basis of a resistance value whether the medium is normal or not. Consequently, a satisfactory signal can be recorded or a satisfactory reproduction signal can be obtained. It is desired that the relation of the deterioration state and jitter is judged on the basis of information previously recorded in the apparatus or the medium. Detailed description thereof will be made in an embodiment 6.

(7) When reproduction is made in the voltage layer selection type multi-layer optical disk, the relation of the resistance between each pair of electrodes and the deterioration state is measured and a voltage is applied to the layer judged that the medium is normal. The relation of the deterioration state and the resistance between the electrodes is judged on the basis of information previously recorded in the apparatus. Consequently, the resistance value between each pair of electrodes is measured and the voltage is applied only to the layer judged that the medium is normal, so that it can be prevented that an unnecessary voltage is applied to the medium which is about to fall in the deterioration state and the deterioration is accelerated. Detailed description thereof will be described in the embodiment 6.

(8) The relation of the resistance between each pair of electrodes or the reproduction signal upon application of the voltage and the deterioration state is measured before recording or reproduction of user data in the voltage layer selection type multi-layer optical disk and the recording or reproduction is made after it is judged that the medium is normal. The relation of the deterioration state and jitter is judged on the basis of information previously recorded in the apparatus or the medium. Consequently, it is judged that the medium is about to fall in the deterioration state, so that measures to display the deterioration state before the medium is deteriorated completely or to save information into another location before the medium is deteriorated, can be taken. As a result of the judgment, when it is in case of “YES”, the medium is normal and the recording/reproducing can be made stably. Detailed description thereof will be made in embodiment 7.

According the above-mentioned structure, even if the reproduced signal is varied due to external and internal environmental variation factors (characteristics of medium, variation in voltage, deterioration of medium and the like), the reproduced signal with high quality can be obtained. Further, even when the electrode is damaged, it can be prevented that the medium is deteriorated completely.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B are schematic diagrams illustrating a concept of a first embodiment of the present invention;

FIG. 2 is a diagram showing effects of the first embodiment of the present invention;

FIG. 3 is a diagram illustrating a learning system in the first embodiment of the present invention;

FIG. 4 is a circuit diagram illustrating the learning system for reproduction in the first embodiment of the present invention;

FIG. 5 schematically illustrates a medium of the first embodiment of the present invention;

FIG. 6 shows the relation of an application voltage and a reproduction signal in the first embodiment of the present invention;

FIG. 7 is a diagram illustrating a learning system in a third embodiment of the present invention;

FIG. 8 is a diagram illustrating a learning system in a fourth embodiment of the present invention;

FIG. 9 shows variation in jitter upon deterioration of media in a seventh embodiment of the present invention;

FIG. 10 shows variation in jitter upon deterioration of media in a sixth embodiment of the present invention;

FIG. 11 is a diagram illustrating a learning system in a fifth embodiment of the present invention;

FIG. 12 is a diagram showing effects of the fifth embodiment of the present invention;

FIG. 13 is a circuit diagram illustrating the learning system for recording in the fifth embodiment of the present invention;

FIG. 14 is a flow chart showing operation of a learning system in the sixth embodiment of the present invention;

FIG. 15 is a flow chart showing operation of a learning system in the seventh embodiment of the present invention;

FIG. 16 is a schematic diagram illustrating an apparatus according to the present invention; and

FIG. 17 is a circuit diagram illustrating a medium state judgment system in the seventh embodiment of the present invention.

### DESCRIPTION OF THE EMBODIMENTS

Embodiments of the present invention are now described with reference to the accompanying drawings.

### Embodiment 1

(Learning System for Reproduction)

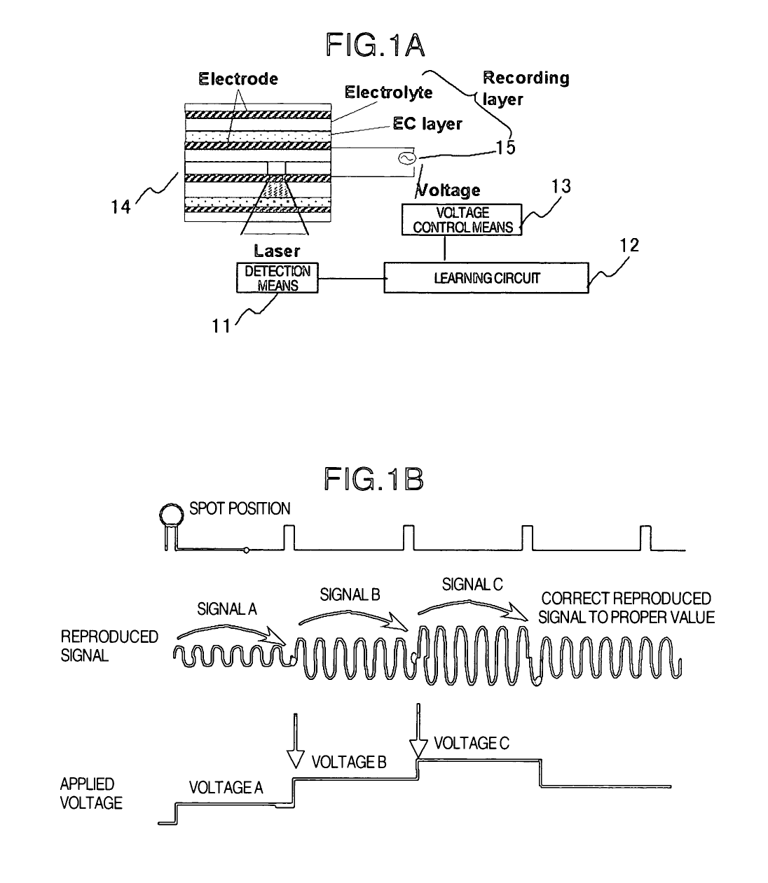

FIGS. 1A and 1B schematically illustrate a reproduction system. In order to reproduce information by means of the reproduction system, a voltage A is first applied between layers to which reproduction is made by means of voltage application means 15 to change electrochromic material into a colored state so that the reflectivity is increased to focus reproduction light on a reproduction plane of a medium 14. Then, a reproduced signal A is examined by using the applied voltage A and detection means 11 in a particular area such as read-in until data is reproduced. Subsequently, reproduced signals B and C are examined for voltages B and C, respectively. A learning circuit 12 examines the relation of the applied voltages and the reproduced signals on the basis of these data to decide the application voltage upon reproduction on the basis of the relation so that a proper application voltage value is sent to voltage control means 13 to adjust the application voltage. FIGS. 1A and 1B show an example in which the relation of the applied voltages and the amplitude of the reproduced signals is examined to control the application voltage into a proper range.

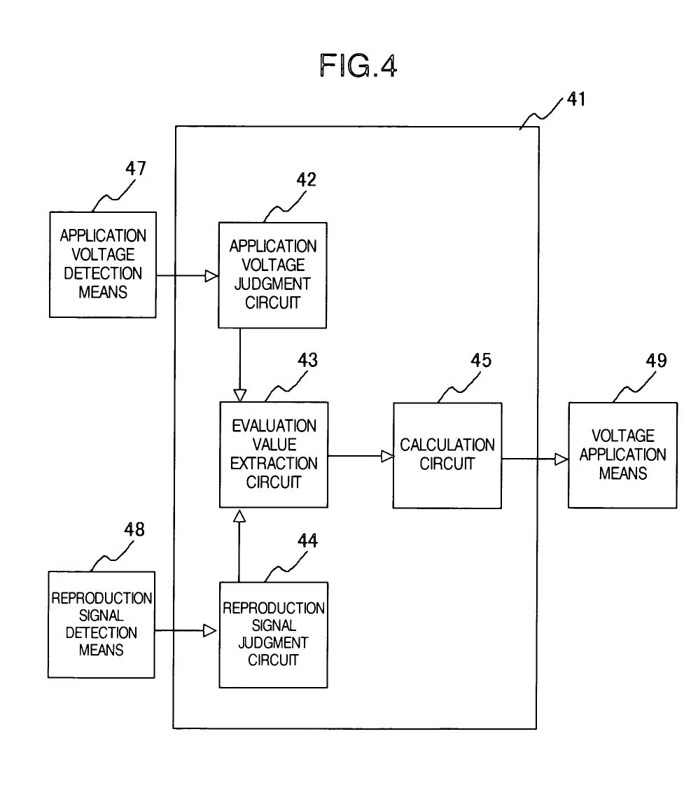

The learning circuit 12 is schematically illustrated in FIG. 4 in detail. An application voltage pattern inputted from application voltage detection means 47 is supplied to an application voltage judgment circuit 42, which judges an application voltage value to supply it to an evaluation value extraction circuit 43. On the other hand, a reproduction signal of each application voltage pattern is detected by reproduction signal detection means 48 to be supplied to a reproduction signal judgment circuit 44, which judges an amplitude value thereof to supply it to the evaluation value extraction circuit 43. The evaluation value extraction circuit 43 extracts an evaluation value on the basis of these data to be supplied to an calculation circuit 45, which calculates an application voltage E to supply it to voltage application means 49. The evaluation value is a reference value calculated from the relation of the reproduction signal and the voltage as E1 calculated below.

The evaluation value extraction circuit 43 and the calculation circuit 45 calculate the application voltage E as follows. In the relation of the application voltage and the signal amplitude, as shown in FIG. 3, the signal amplitude is saturated at a proper voltage and is reduced at a voltage exceeding the proper voltage. A satisfactory range of the signal amplitude is varied in the range from the case where the number of voltage applications is decreased (for example one time) to the case where the number of voltage applications is increased (for example ten thousand times), although the behavior thereof in the low voltage area is the same. Accordingly, the range of the proper voltage value by which a large signal amplitude is obtained regardless of the number of voltage applications is equal to or larger than Ep and equal to or smaller than Es and is, when a voltage showing a half Mmax/2 of a saturated value Mmax of the signal amplitude is E1, expressed by the function of the voltage. That is, the application voltage E is calculated to satisfy the following expressions (1), (2) and (3) and is applied to thereby obtain the large signal amplitude.
Ep≦E≦Es (1)
Ep=E1×1.1 (2)
Es=E1×2.2 (3)

As described above, when a voltage calculated in accordance with the expressions by the calculation circuit 45 is applied by means of the voltage application means 49, the reproduction signal is as satisfactory as 0.9 when the voltage is applied the first time and many times. In this manner, the proper voltage can be applied by the learning for reproduction, so that the satisfactory reproduction signal can be obtained and it can be prevented that the reproduction signal is deteriorated when the voltage is applied many times.

As described above, the reason that there is the proper value in the application voltage is that when the application voltage is lower than the proper value, the signal amplitude is lower than 0.8 within a satisfactory range of the amplitude and when the application voltage is higher than the proper value, the signal amplitude is within the satisfactory range if the number of voltage applications is small, although when the number of applications is increased, the signal amplitude is smaller than the satisfactory range. When the application voltage higher than the proper value is applied, there occurs a problem that the reflectivity is not lowered upon disappearance of color and accordingly the signal amplitude becomes small. When the application voltage is within the proper range, the signal amplitude is satisfactory as it is high even if the voltage is applied ten thousand times.

It is understood from the foregoing that the proper application voltage is obtained from the relation of the reproduced signal and the application voltage and is, when a voltage showing a half Mmax/2 of a saturated value Mmax of the signal amplitude is E1, expressed by the function of E1 when the signal amplitude of the reproduced signal is used to make learning and the satisfactory reproduced signal is obtained when the proper application voltage is applied.

Reference patterns A to C of the application voltage for obtaining the relation of the reproduction signal and the application voltage as described above or a table for obtaining the patterns may be recorded in a disk or a reproduction apparatus. In this description, in order to make clearly understandable, three kinds of patterns are provided, although it is desired that five or more kinds of patterns are used to make detailed examination actually. As shown in FIG. 3, it is desired that an area from voltages Ep to Es where the signal amplitude is maintained to be 0.8 is previously examined, so that the application voltage is set within this area. This reason is that when the application voltage is too high, the reflectivity is not varied upon disappearance of color.

Further, in the embodiment, the voltage pattern has a fixed level of voltage value by way of example, although a pulsed voltage may be applied. When the direction of voltage application is regularly arranged, even an average voltage value of the pulsed voltage may be used to attain the same effects. An amount of current to be applied can be also used to make control, although the accuracy is more improved in case of the voltage control as compared with the current control.

The relation of Ep, Es and E1 is as described in the expressions (2) and (3) in the embodiment and coefficients of the relation expressions are scattered slightly in each medium. Accordingly, it is desired that the values may be corrected to be used when these values are described for each medium. When the values are not described for each medium, general values described in the reproduction apparatus are used.

Further, when the proper voltage value as calculated above is recorded in the reproduction apparatus or the disk, the operation time can be shortened in the next learning. When the proper voltage value is recorded in the disk, the learning time can be shortened even if another reproduction apparatus is used to make reproduction. Further, the last learned value may be used to decide the application voltage for the second and subsequent reproduction in order to shorten the time up to reproduction. However, when the learning is made periodically, it takes excessive time to make adjustment but the system is resistant to variation in environment.

In addition, even if an average value of signal levels is detected instead of the signal amplitude, the same learning can be made. If the reference signal having a large signal amplitude is used, the accuracy is more improved, although a random signal may be used besides the reference signal.

### Comparison Example 1

Next, in order to verify the effects of the learning for reproduction of the present invention, the reproduction characteristic of the information recording medium stored under increased humidity has been examined as an example of large variation in environment. As a result of comparison of the reproduced signal in case where the learning has been made with that in case where the learning has not been made (Compared Example), the results as shown in Table 1 are obtained.

TABLE 1

| | Reproduced signal 1 | Reproduced signal 2 |
|---|---|---|
| | (Invention) | (Compared Example 2) |
| Applied voltage | 3 V | 2 V |
| Upon reproduction | | |
| Signal amplitude | 0.9 | 0.3 |
| Reflectivity | 11% | 4% |
| Jitter | 6% | 24% |
| Error rate | 10⁻⁵ or less | 2 × 10⁻³ |

The proper application voltage is calculated to make correction by the learning for reproduction and accordingly the satisfactory reproduction signal is obtained as the reproduced signal 1 shown in Table 1. In the compared example, the application voltage value recorded in the reproduction apparatus is used as it is, while since the surface of electrodes of the information recording medium is unclean and a resistance thereof is increased, a proper voltage is not applied to recording layers even if a previously provided application voltage is applied, so that variation in the reflectivity is considered to be small. Accordingly, the amplitude, the reflectivity, the jitter and the error rate of the reproduced signal 2 are not satisfactory.

As described above, by applying the learning for reproduction of the present invention, the proper voltage can be applied to obtain the satisfactory reproduced signal even for external and internal environmental variation factors (variation in optical characteristics and electrical characteristics and deterioration of the medium and the reproduction apparatus and the like).

### Comparison Example 2

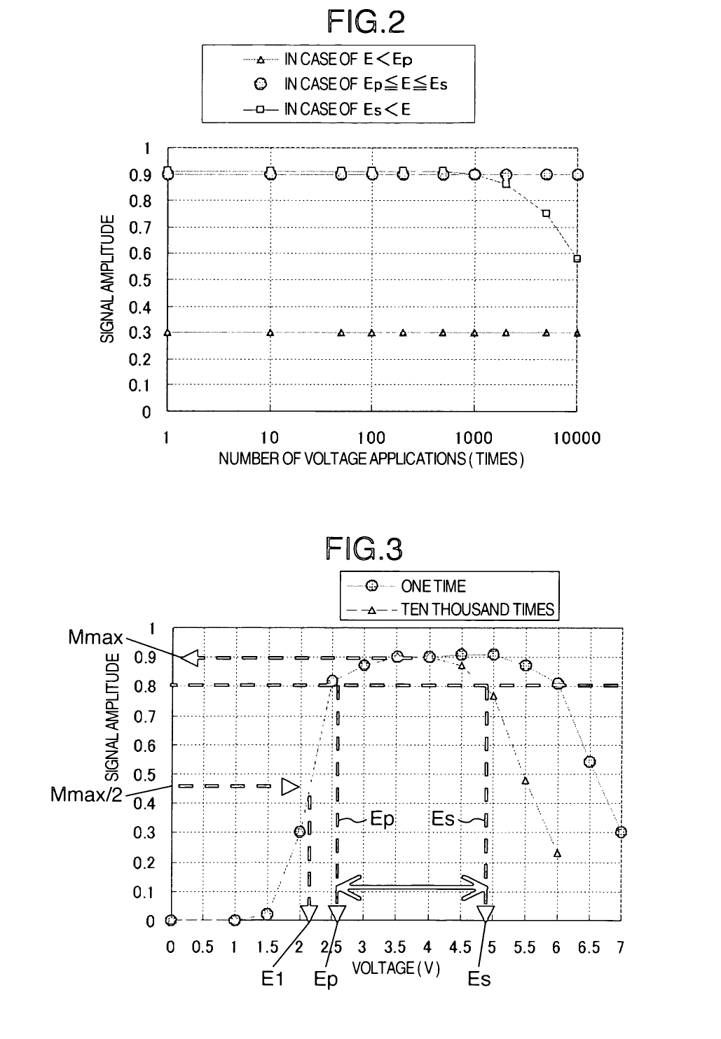

Further, in order to verify the effects of the learning for reproduction of the present invention, examples where the application voltage is too high (Es<E) and it is too low (E<Ep) are examined and its results are shown in FIG. 2.

With regard to the reproduced signal (in case of Ep≦E≦Es) of the present invention, the proper application voltage is calculated to make correction by the learning for reproduction and accordingly the satisfactory reproduced signal can be obtained even after the voltage is applied many times. However, when a lower application voltage is used without making the learning for reproduction as shown by the reproduced signal of the compared example (E<Ep), the signal amplitude is low and is not satisfactory. When a high application voltage is used without making the learning for reproduction as shown by the reproduced signal of the compared example (Es<E), the signal amplitude is high at the beginning, although the signal amplitude becomes low as the number of voltage applications is increased and is not satisfactory.

As described above, by applying the learning for reproduction of the present invention, the proper voltage can be applied to obtain the satisfactory reproduced signal even for external and internal environmental variation factors (variation in optical characteristics and electrical characteristics and deterioration of the medium and the reproduction apparatus and the like).

(Configuration of Apparatus)

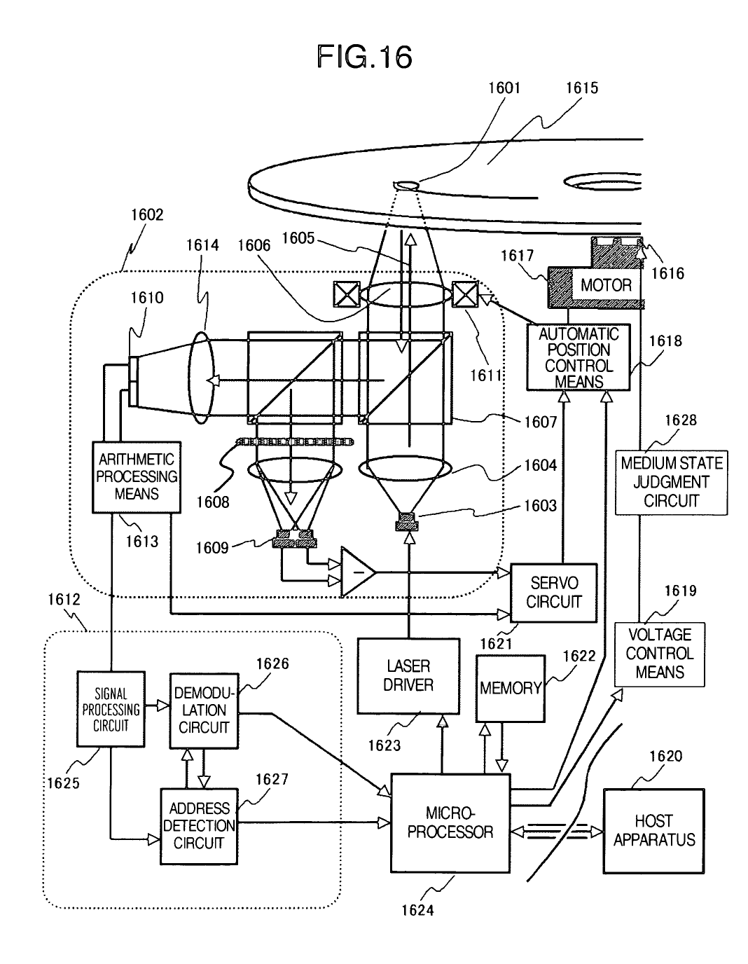

FIG. 16 is a block diagram schematically illustrating the information reproducing apparatus.

When a host apparatus 1620 issues a “reproduction” command to the information recording/reproducing apparatus, a microprocessor 1624 stores a basic pattern of the application voltage for the learning for reproduction received from the host apparatus 1620 in a memory 1622. After a motor 1617 is rotated, voltage control means 1619 applies a voltage to a medium 1615 through electrodes 1616 in accordance with the pattern stored in the memory. At the same time, the microprocessor 1624 sends a reproduction operation command to a laser driver 1623. Light (wavelength thereof is about 660 nm) radiated by a laser light source 1603 constituting a part of a head 1602 is collimated into substantially parallel light beam 1605 through a collimating lens 1604. The optical information recording medium 1615 is irradiated with the light beam 1605 through an objective lens 1606 and a spot 1601 is formed on the information recording medium 1615. Light reflected by the medium at the spot 1601 is then led through beam splitters 1607 and a hologram element 1608 to a servo detector 1609 and through a lens 1614 to a signal detector 1610. Signals from the detectors are subjected to arithmetic processing such as addition and subtraction in arithmetic processing means 1613 and are converted into servo signals such as a tracking error signals and a focus error signals to be supplied to a servo circuit 1621. The servo circuit 1621 controls positions of driving means 1611 of the objective lens 1606 and the whole optical head 1602 on the basis of the tracking error signal and the focus error signal to position the light spot 1601 to a target record/reproduction area. Addition signal of the detector 1610 is inputted to a signal reproduction block 1612. The inputted signal is subjected to filter processing, frequency equalization processing and the like in a signal processing circuit 1625 to thereby be digitized. The digitized signal is processed by an address detection circuit 1627 and a demodulation circuit 1626. The microprocessor 1624 calculates the position of the light spot 1601 on the information recording medium on the basis of the address signal detected by the address detection circuit and controls automatic position control means 1618 to thereby position the optical head 1602 and the light spot 1601 to a target record unit area (sector). In this manner, the microprocessor 1624 reads out the reproduction signal for each application voltage pattern and makes learning.

When the host apparatus 1620 issues a recording command to the information recording/reproducing apparatus, the microprocessor receives record data from the host apparatus to be stored in the memory and controls the automatic position control means to position the light spot 1601 to the target record area. The microprocessor confirms that the light spot 1601 is positioned to the record area exactly in accordance with the address signal from the signal reproduction block 1602 and then controls a laser driver to record the data stored in the memory into the target record area.

The information reproduction apparatus has made recording and reproducing of information to the information recording medium. Operation of the information reproduction apparatus is now described. The motor control method in case where recording/reproduction is made adopts the Zoned Constant Linear Velocity (ZCAV) system in which the rotational number of the disk is varied for each zone in which recording/reproduction is made. The linear velocity of the disk is about 5 m/s.

The 8-16 modulation system has been used to record information in the disk. The information from the outside of the recording apparatus is transmitted to a modulator in 8-bit unit. In the modulation system, the information is recorded in the medium in a record mark length of 3 T to 11 T corresponding to the 8-bit information. T represents a clock period in recording of information and is defined to be 17.1 ns in the embodiment.

The digital signal of 3 T to 11T converted by the modulator is transferred to a recording waveform generation circuit. The recording waveform generation circuit causes the signal of 3 T to 11T to correspond to “0” and “1” alternately in the time series manner. When the signal is caused to correspond to “0”, irradiation is made with laser power of a bottom power level and when it is caused to correspond to “1”, irradiation is made with high-power pulse or pulse train.

Further, the recording waveform generation circuit has a multi-pulse waveform table corresponding to the system (adaptive-type recording waveform control) which varies pulse widths of the head pulse and the last pulse of the multi-pulse waveform in accordance with the length of space portions before and behind mark portions when a series of high-power pulse trains for forming the mark portions is generated, so that the multi-pulse recording waveform capable of eliminating influence of inter-mark thermal interference generated between the marks to the utmost is generated.

In the embodiment, the ZCAV system is used, although another rotation control system may be used. Further, the laser wavelength, the linear velocity, the modulation system, the recording power and the recording waveform may be also different from those described above.

(Structure of Medium)

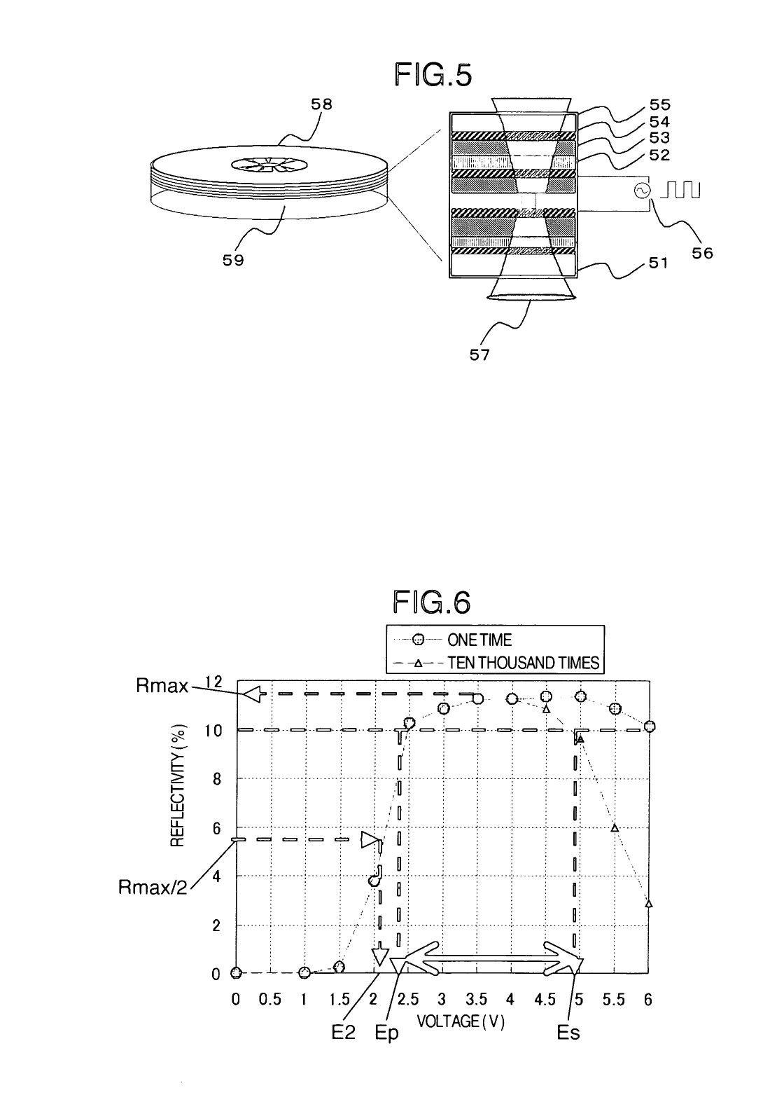

The information recording medium of the present invention is structured as follows. As shown in FIG. 5, an information recording medium 59 is formed of several layers. Two sets or more of a transparent electrode layer 54, an electrochromic material layer 52, an electrolyte material layer 53 and a transparent electrode layer 54 are piled up on one another repeatedly in order of the description to form a laminated structure. In the embodiment, for the simplification of description, three sets of layers are formed by way of example. When the electrochromic material layer 52 and the electrolyte material layer 53 are piled up in order of the description, a driving voltage is reduced, although the layers 52 and 53 may be piled up in reverse order thereto. A transparent electrode layer may be formed for the electrochromic material layer and the electrolyte material layer through a dummy layer without using the transparent electrode layers in common. The transparent electrode layers 54 are connected to a taking-out electrode 58 disposed in the middle of the medium and are used to apply a voltage between the layers through the taking-out electrode.

As apparent from FIG. 5, an upper transparent electrode in a lower layer set disposed on the lower side is utilized as a lower transparent electrode in an upper layer set disposed directly over the lower layer set. It is desired that the absorption factor and/or the reflectivity of the recording or reading-out laser beam is increased when a voltage is applied between electrodes between which the recording layer is held. Consequently, only a desired layer can be adapted to absorb light and other layers can be adapted to hardly absorb light. When a plurality of recording layers are provided in a usual medium, a signal at the inner layer is attenuated to be degraded due to absorption by the layer disposed on the incident side of light and accordingly it is difficult to provide multiple layers in order to increase the capacity. Further, high recording power is required in order to make recording in the inner layer and wide space between layers is required in order to prevent leakage of signals from other layers, so that a large-scale focusing mechanism is required in an optical system and the structure of the apparatus is complicated. The information recording medium of the present invention has not such influence by other layers, so that the provision of the multiple layers, the large capacity and the simple structure of the apparatus can be attained.

The recording medium having the plurality of recording layers as described above is used and a voltage is applied between many electrode pairs but in this case only the electrode pair disposed on both sides of the layer in which recording, erasing or reading is made is applied with a voltage different from voltages applied to other electrode pairs. The different voltage contains a voltage having the opposite polarity. A voltage in the coloring direction may be opposite in sign and different in value of a voltage in the color disappearing direction. In this manner, a desired recording layer can be selectively colored and the colored layer can be irradiated with light to make recording or reproducing of information.

Further, in the present invention, the electrochromic material layer is defined to be a material layer which is directly color-developed (absorption or reflection spectrum is varied) by application of a voltage (current flows). Material that is not named electrochromic material currently may be used. Tungsten oxide and molybdenum oxide may be used as the electrochromic material by way of example.

(Material, Layer Manufacturing Method and Recording)

The electrochromic material layer is color-developed by applying a voltage between upper and lower electrodes which are disposed to hold the electrochromic material layer therebetween. In the embodiment, the electrochromic material layer uses a mixture of tungsten oxide and molybdenum oxide suitable for the case where a laser having a wavelength of 660 nm or a blue laser having a wavelength of about 405 nm is used in the light source. Tantalum oxide is used as the electrolyte material. Since the uniformity in thickness of the layer is regarded as important, layers is formed by sputtering, although the ion plating or evaporation method may be used to form the layers.

ITO layer is used as the transparent electrode layer, although the transparent electrode may be made of known transparent electrode material such as material having the composition of (In₂O₃)ₓ or (SnO₂)₁₋ₓ in which x is within the range of 5 to 99% or more preferably in respect of a resistance value material having the same composition in which x is within the range of 90 to 98% or the same material as described just before with the exception that SiO₂ of 50% or less in mole percent is added thereto or SnO₂ to which another oxide such as Sb₂O₃ of 2 to 5% in mole percent is added thereto. Another transparent conductive layer such as ZnO layer may be used.

When the electrochromic layer or solid electrolyte layer is adapted to be phase-changed between crystal and amorphous materials or between crystal materials to thereby make recording, the possibility of rewriting information can be expected. If the coloring or color disappearing speed can be made to be different by one digit or more depending on the phase, reading-out can be made by reading out only the area in either phase in the colored state after application of voltage. With inorganic material such as WO₃, plus ions are apt to be moved in the amorphous state and its speed is increased.

As another method, an organic or inorganic material layer having at least one of the refractive index and the extinction coefficient varied by the physical change (phase change) or the chemical change (for example, reaction to Li ion) caused by heat or current may be piled up as another layer to make recording by change of this layer. For example, a conductive material layer having an absorption end changed by temperature increased by current or preheated laser beam is used.

Further, as still another method, magnetic material having the direction of magnetization varied by heat or current and magnetic field may be used to be formed as a recording layer in adjacent to the electrochromic material or solid electrolyte material. For example, transparent optical magnetic material such as garnet is considered and it is designed that magnetization is reversed when the temperature rises.

If the optical thickness of layers between the transparent electrodes is equal to substantially one wavelength of reading light or the integral multiple thereof, any recording layer is desirably equivalent optically.

### Another Example of Substrate

In the embodiment, a polycarbonate substrate having a tracking groove formed directly in the surface is used. The substrate having the tracking groove is that having a groove formed in the whole or partial surface of the substrate and having the depth equal to or larger than λ/15n (n represents the refractive index of substrate material) when the recording/reproducing wavelength is λ. The groove may be formed continuously at one round or may be divided on the way. It is understood that the depth of the groove is preferably equal to about λ/12n in respect of the balance of tracking and noise. Further, the width of the groove may be different depending on locations. Even a substrate formed in the format for making recording/reproducing in both of the groove and the land, even a substrate formed in the format for making recording in any one of the groove and the land or even a substrate formed in the sample servo format in which servo marks for tracking are provided intermittently may be used. With the substrate of the type of making recording in only the groove, it is desired that the track pitch is equal to about 0.7 times of NA (numerical aperture) of a wavelength/focusing lens and the width of the groove is equal to about a half thereof. Addresses may be expressed by wobbling of the groove or may be expressed by a pit train in the groove or land, although it is desired that the addresses expressed by wobbling are difficult to be influenced by deformation caused by the laminated structure.

A spacer layer having the thickness of 20 to 40 μm may be provided at intervals of several layers (for example, at intervals of 10 layers) of the multiple recording layers. It is desired that an uneven pattern containing at least one of tracking grooves and pits is transferred to the spacer layer from a nickel stamper and is used to detect tracking signal, address, clock and synchronous signal. In this case, when two or more spacer layers are used, it is desired that an element for compensating the spherical aberration is provided in the optical system.

When recording/reproducing light is incident from the side of the stuck substrate, the stuck substrate may be thinned by about 0.1 mm and NA (numerical aperture) of the focusing lens is made as large as 0.85. As constructed above, the track pitch can be made equal to about ¾.

When the medium is formed into a concentric circle, the transparent electrodes have the internal diameter which is increased little by little as it is far from the substrate and the transparent electrode nearest to the substrate is exposed in the form of ring at the most interior side, for example, so that a voltage can be applied therefrom. The transparent electrode disposed thereon is exposed in the form of ring with a slightly larger diameter. The transparent electrodes for the layers are formed as an inner peripheral mask is increased little by little so that the electrodes are exposed in the form of concentric circle at the inner periphery. If a ring-shaped metal portion is disposed in the exposed portion with a width slightly narrower than the width in its radial direction (for example 90%) so that the conductivity and the mechanical strength are increased, the manufacturing cost is slightly increased but it is preferable in respect to performance especially.

The main points of the recording medium are now summarized. The recording medium is to record information by irradiation of light and is characterized in that two or more layers of unit structures each including a material layer (single or plural layers) having the light absorption or the reflection spectrum varied at least by application of a voltage and held between transparent or semitransparent electrodes are piled up to form a laminated structure and the transparent electrodes or ends thereof extending from the transparent electrodes are exposed at the inner periphery of the disk concentrically or radially, further another substrate being stuck thereon. It is desired that a plurality of metal pins reaching the opposite surface are disposed at a part of at least one of the substrates while penetrating the substrate or bypassing the vicinity of a central hole of the substrate and a concentric electrode is disposed on the surface side of the substrate. The concentric electrode may be discontinuous and a plurality of electrodes may be arranged concentrically. The plurality of electrodes are not set to have the same potential and may correspond to different transparent electrodes of the recording area. It is further desired that material containing minute particles of metal or carbon is applied or stuck to the portion being in contact with the electrode of the opposite side substrate to which the electrode is stuck or the electrode on the side of a drive apparatus to be strengthened.

### Embodiment 2

In the embodiment 2 of the present invention, an example of the learning for reproduction for adjusting the application voltage from the reflectivity of the reproduction signal is described.

(Learning System for Reproduction)

In order to obtain an optimum application voltage from the reflectivity of the reproduction signal, the relation as shown in FIG. 6 is used. As shown in FIG. 6, the application voltage and the reflectivity are related so that the reflectivity is saturated at a proper voltage and is reduced at a voltage higher than the proper voltage. A satisfactory range of the signal amplitude is different in the range from the case where the number of voltage applications is reduced (for example, one time) to the case where the number of voltage applications is increased (for example, ten thousand times) but operation in a low-voltage area is the same in the range. The range of the proper voltage value by which the large reflectivity is obtained regardless of the number of voltage applications is equal to or higher than Ep and equal to or lower than Es and is, when the voltage showing a half Rmax/2 of a saturated value Rmax is E2, expressed by the function thereof. That is, an application voltage E is calculated to be within the range defined by the expressions (1), (4) and (5) and is applied to thereby obtain an increased reflectivity.
Ep=E2×1.1 (4)
Es=E2×2.2 (5)

When the calculation circuit 45 calculates a voltage value in accordance with the expressions and the calculated voltage is applied by means of the voltage application means 49, the reflectivity was as satisfactory as 10% at the time that the voltage is applied first and many times. The reason that the reflectivity is made equal to or larger than 10% is that the reflectivity by which reproduction signal can be produced stably with a margin is equal to or larger than 10%.

As described above, the proper voltage can be applied by the learning for reproduction to thereby obtain the satisfactory reproduced signal and prevent the reproduced signal from being deteriorated when the voltage application is made many times.

The reason that there is the proper value in the application voltage is that when the application voltage is lower than the proper value, the reflectivity is lower than 10% within a satisfactory range of the reflectivity and when the application voltage is higher than the proper value, the reflectivity is within the satisfactory range if the number of voltage applications is small, although when the number of applications is increased, the reflectivity is smaller than the satisfactory range. When the application voltage higher than the proper value is applied, there occurs a problem that the reflectivity is not varied upon disappearance of color and accordingly the reflectivity becomes small. When the application voltage is within the proper range, the reflectivity is satisfactory as it is high even if the voltage is applied ten thousand times.

It is understood from the foregoing that the proper application voltage is obtained from the relation of the reproduced signal and the application voltage and is, when a voltage showing a half Rmax/2 of a saturated value Rmax of the reflectivity is E2, expressed by the function of E2 when the reflectivity of the reproduced signal is used to make learning and the satisfactory reproduced signal is obtained when the proper application voltage is applied.

As described above, the proper application voltage can be learned from the reflectivity of the reproduced signal. The reflectivity can be detected even in the state that the disk begins to be rotated and it is not necessary to make synchronization like a signal. Accordingly, the learning for reproduction can be started during the period starting after the disk is set and continuing until reproduction is made, for example before the rotational number reaches a fixed value, and the learning for reproduction can be made in a short time.

The learning system, the structure of the medium, the material, the information recording method, the information reproducing method and the apparatuses thereof which are not described in the embodiment are the same as those of the embodiment 1.

### Embodiment 3

In the embodiment 3 of the present invention, an example of the learning for reproduction for adjusting the application voltage from jitter of the reproduction signal is described.

(Learning System for Reproduction)

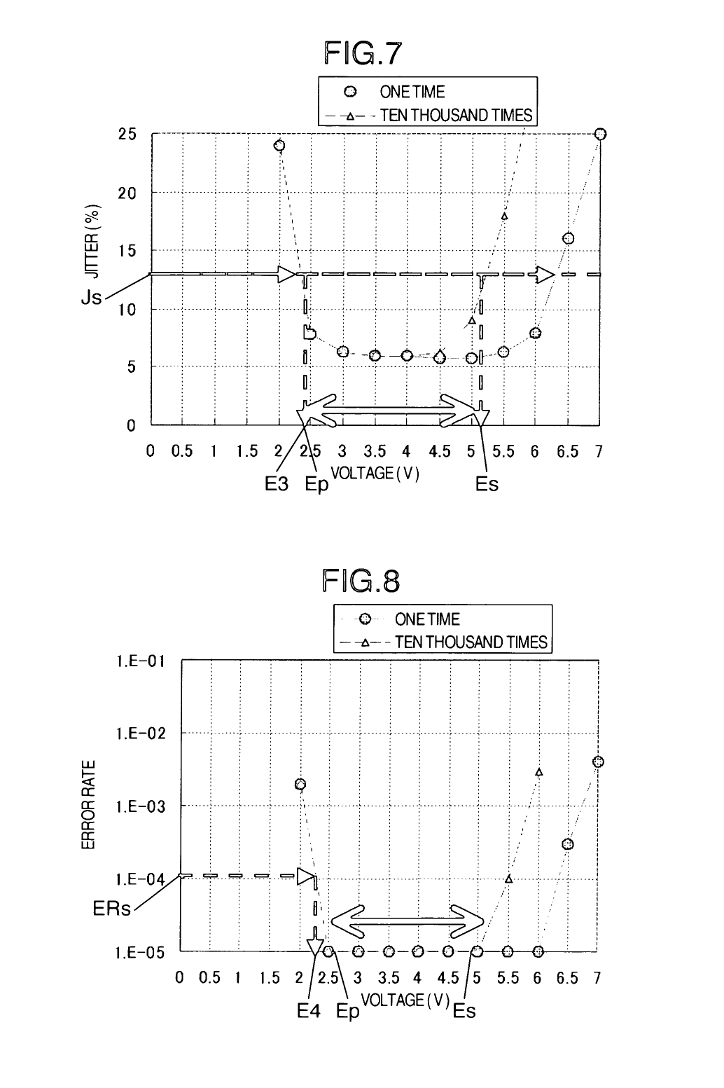

In order to obtain an optimum application voltage from jitter of the reproduction signal, the relation as shown in FIG. 7 is used. A random signal pattern from 3 T to 11 T is reproduced and the jitter or fluctuation of signal and the application voltage are related so that jitter is reduced at a proper voltage and is increased at a voltage higher than the proper voltage as shown in FIG. 7. A satisfactory range of jitter is different in the range from the case where the number of voltage applications is reduced (for example, one time) to the case where the number of voltage applications is increased (for example, ten thousand times) but operation in a low-voltage area is the same in the range. The range of the proper voltage value by which small jitter is obtained regardless of the number of voltage applications is equal to or higher than Ep and equal to or lower than Es and is, when a voltage showing a reference jitter value Js is E3, expressed by the function thereof. That is, an application voltage E is calculated to be within the range defined by the expressions (1), (6) and (7) and is applied to thereby obtain small jitter. The reference jitter value Js is 13% equal to a maximum value by which the signal can be reproduced correctly.
Ep=E3×1.1 (6)
Es=E3×2.1 (7)

When the calculation circuit 45 calculates a voltage value in accordance with the expressions and the calculated voltage is applied by means of the voltage application means 49, the jitter was as satisfactory as 13% or less.

As described above, the proper voltage can be applied by the learning for reproduction to thereby obtain the satisfactory reproduced signal and prevent the reproduced signal from being deteriorated when the voltage application is made many times.

As described above, the reason that there is the proper voltage in the application voltage is the same as the embodiment 1.

It is understood from the foregoing that the proper application voltage is obtained from the relation of the reproduced signal and the application voltage and is, when a voltage showing to the reference value Js of jitter is E3, expressed by the function of E3 when the jitter of the reproduced signal is used to make learning and the satisfactory reproduced signal is obtained when the proper application voltage is applied.

As described above, the proper application voltage can be learned from the jitter of the reproduced signal. Since detection of jitter can be used even for learning for recording, the learning for reproduction and the learning for recording can be combined to shorten the time for preparation of recording and since the learning accuracy is improved in the recording medium, the number of reproducible operations can be improved. Further, even when the reproduction state is varied just a little from the very good reproduction state, it is understood that the level of jitter is varied and accordingly a sign that the reproduction signal begins to be deteriorated can be detected. Consequently, the sign that the reproduction signal begins to be deteriorated can be decided to thereby save information into another location before the reproduction signal is deteriorated completely. The learning system, the structure of the medium, the material, the information recording method, the information reproducing method and the apparatuses thereof which are not described in the embodiment are the same as those of the embodiments 1 and 2.

### Embodiment 4

In the embodiment 4 of the present invention, an example of the learning for reproduction for adjusting the application voltage from an error rate of the reproduction signal is described.

(Learning System for Reproduction)

In order to obtain an optimum application voltage from an error rate of the reproduction signal, the relation as shown in FIG. 8 is used. When the reference reproduction signal having edges exceeding 10⁵ and the pattern that is previously known is reproduced, the error rate and the application voltage are related so that the error rate is reduced at a proper voltage and is increased at a voltage higher than the proper voltage as shown in FIG. 8. The satisfactory range of the error rate is different in the range from the case the number of voltage applications is reduced (for example, one time) to the case where the number of voltage applications is increased (for example, ten thousand times) but operation in a low-voltage area is the same in the range. The range of the proper voltage value by which small jitter is obtained regardless of the number of voltage applications is equal to or higher than Ep and equal to or lower than Es and is, when a voltage showing a reference error rate ERs is E4, expressed by the function thereof. That is, an application voltage E is calculated to be within the range defined by the expressions (1), (8) and (9) and is applied to thereby obtain a small error rate. The reference error rate ERs is 10E-4 equal to a maximum value that can be corrected when an error occurs in the reproduction signal.
Ep=E4×1.1 (8)
Es=E4×2.1 (9)

As described above, the proper application voltage can be learned from the error rate of the reproduction signal. Since detection of the error rate can be used even for learning for recording, the learning for reproduction and the learning for recording can be combined to shorten the time for preparation of recording and since the learning accuracy is improved in the recording medium, the number of reproducible operations can be improved. Since the number of errors is counted to calculate the error rate, the state of deterioration can be grasped exactly even when the reproduction signal is deteriorated to some degree. Consequently, the state just before deterioration can be judged to save information into another location before the reproduction signal is deteriorated completely.

The learning system, the structure of the medium, the material, the information recording method, the information reproducing method and the apparatuses thereof which are not described in the embodiment are the same as those of the embodiments 1 to 4.

### Embodiment 5

In the embodiment 5 of the present invention, an example of the learning for recording is described.

(Learning System for Recording)

First, a write once recording medium is used to describe the learning system for recording. In order to record information by means of the recording system of the embodiment, first, a voltage A is applied between the layers for making recording/reproducing by means of the voltage application means 15 (FIG. 1) to change the electrochromic material into the colored state so that the reflectivity is increased to focus the reproduction light on the reproduction plane of the medium 14. Thereafter, a recording pattern D is recorded in a specific area such as a test area in the state of the application voltage A and the detection means 11 is used to examine a reproduced signal AD. Subsequently, recording patterns E and F are recorded to examine reproduced signals AE and AF. Then, reproduced signals BD, BE and BF and CD, CE and CF are examined for voltages B and C, respectively. The learning circuit 12 examines the relation of the application voltage, the recording patterns and the reproduced signals on the basis of these data and the application voltage for recording and the recording pattern are decided on the basis of the relation to supply a proper application voltage to the voltage control means 13. The application voltage is adjusted and a proper recording pattern is sent to recording pattern control means to adjust the recording pattern.

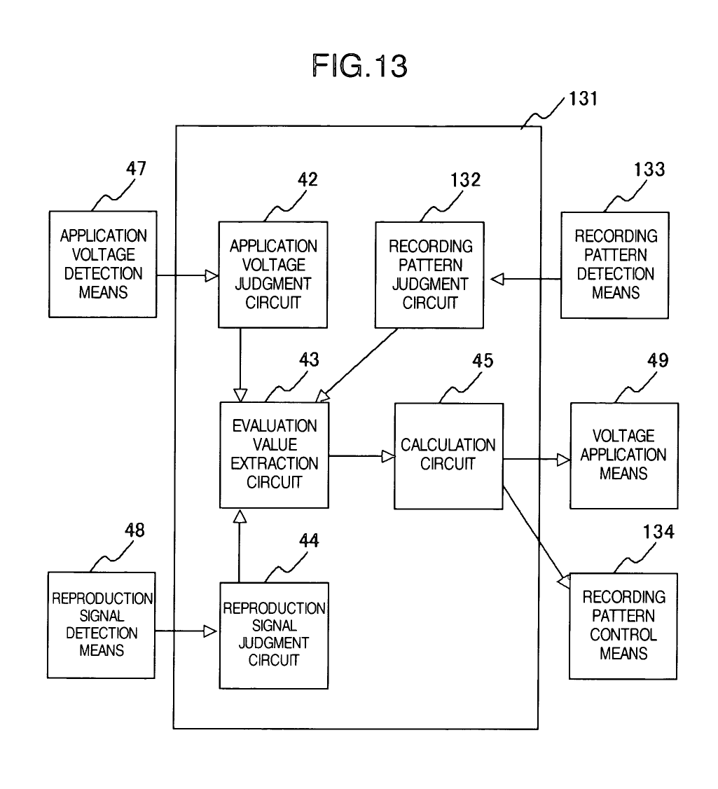

A learning-for-recording circuit 131 is schematically illustrated in FIG. 13 in detail. An application voltage pattern inputted from the application voltage detection means 47 is supplied to the application voltage judgment circuit 42, which judges an application voltage value to supply it to the evaluation value extraction circuit 43. A recording pattern inputted from recording pattern detection means 133 is supplied to a recording pattern judgment circuit 132, which judges the recording pattern, for example recording power, and supplies its value to the evaluation value extraction circuit 43. As the recording pattern, recording power, recording pulse duty, assist power, head pulse width, trailing pulse width and the like are considered. In the embodiment, the recording power is used by way of example.

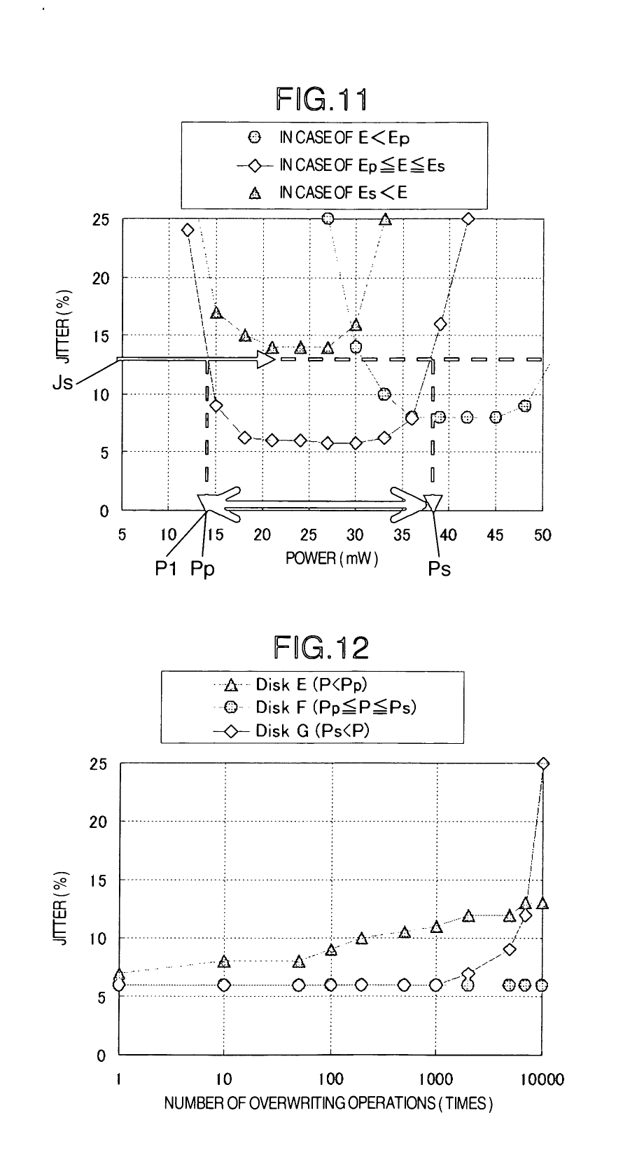

On the other hand, the reproduction signal obtained by a matrix of the application voltage patterns and the recording patterns is detected by the reproduction signal detection means 48 and its amplitude value is judged by the reproduction signal judgment circuit 44 to be supplied to the evaluation value extraction circuit 43. The evaluation value extraction circuit 43 extracts an evaluation value on the basis of the data. In the application voltage, the recording power and the jitter, as shown in FIG. 11, when the voltage is proper (Ep≦E≦Es), there is a wide recording power margin, although when the voltage is too low (E<Ep), the recording power margin is narrow and the recording power having low jitter is increased. When the voltage is too high (Es<E), jitter is maintained to be high. In this manner, the voltage is selected so that the recording power margin having the reference jitter value Js or less is increased. Further, when power having the reference jitter value Js is defined to P1, the recording power is calculated by the expressions (10), (11) and (12).
Pp≦P≦Ps (10)
Pp=P1 (11)
Ps=P1×2.7 (12)

When recording is made by the recording power calculated in accordance with the expressions by the calculation circuit 45, jitter is as satisfactory as 6%. When the power is too low, jitter is as bad as 14%. When the power is too high, jitter is 8% in a single track, whereas when recording is made in both adjacent tracks, jitter is deteriorated to 15%. This is caused by crosstalk from the adjacent tracks. In this manner, since the proper voltage and the recording power can be applied by the learning for recording to thereby prevent crosstalk from the adjacent tracks, the satisfactory reproduction signal can be obtained and it can be prevented that the reproduction signal is deteriorated when the voltage application is made many times.

The application voltage patterns A to C and the recording patterns E to F for obtaining the relation of the application voltage, the recording power and the reproduction signal or tables for obtaining the patterns may be recorded in the disk or reproduction apparatus. In addition, even if the reflectivity, the signal amplitude or the error rate is used as an index besides jitter, the learning for recording is made similarly.

Further, the learning for recording can be simplified. In this case, the learning for reproduction is made by the method described in the embodiments 1 to 4 to decide the proper application voltage. Thereafter, it is desired that the relation of the recording pattern and the reproduction signal is examined to decide the proper recording pattern. When the application voltage is decided by the learning for reproduction after the recording pattern is decided, the proper range cannot be necessarily obtained occasionally. In the learning for recording simplified as above, the proper application voltage range or the proper recording power range, that is, the margin is reduced by about 5% as compared with the satisfactory signal range obtained by the learning for recording, although the learning time can be shortened.

In addition, the recording/reproducing system can be applied to not only the write once recording medium but also the rewritable recording medium. FIG. 12 shows deterioration states of recording layers when rewriting is made many times in case where the learning for recording is made to the rewritable recording medium and in case where it is not. When the learning for recording is not made and the recording power is too low (P<Pp), jitter is gradually deteriorated in accordance with the number of rewriting operations. When the learning for recording is not made and the recording power is too high (Ps<P), a jitter value is satisfactory until the number of rewriting operations reaches a certain value but, when it exceeds the certain value (for example a thousand times), jitter is suddenly deteriorated and exceeds a jitter value with which a signal can be reproduced exactly. When the learning for recording is made and the recording pattern is proper (Pp≦P≦Ps), the jitter value is maintained to be satisfactory even after the overwriting is made many times. As described above, deterioration of the record signal can be prevented by the learning for recording even when the overwriting is made many times.

The learning system, the structure of the medium, the material, the information recording method, the information reproducing method and the apparatuses thereof which are not described in the embodiment are the same as those of the embodiments 1 to 4.

### Embodiment 6

In the embodiment 6 of the present invention, an example in which the deterioration state of the information recording medium can be monitored when the reproduction is made is described.

(Medium State Judgment System)

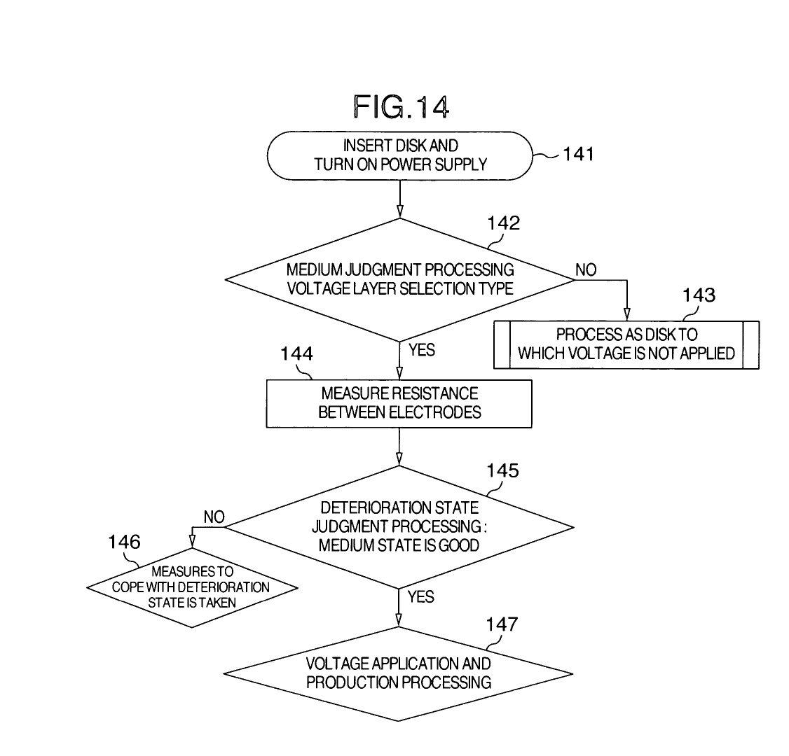

FIG. 14 shows a processing flow for detecting the state of a disk on the basis of deterioration of a resistance value between electrodes. In order to examine the deterioration state of the information recording medium by means of the system of the present invention, after the disk is inserted into the apparatus and/or the power supply is turned on (step 141), the medium is distinguished to decide whether it is the voltage layer selection type or not in medium judgment processing of step 142. When it is not the voltage layer selection type (In case of “NO” in step 142), it is treated as a disk to which a voltage is applied in step 143. When it is the voltage layer selection type (In case of “YES” in step 142), a resistance between electrodes is measured in step 144. The deterioration state is next judged on the basis of a reference value measured in step 144 while collating the relation of the resistance value and the deterioration state in deterioration state judgment processing of step 145. When there is a problem in the deterioration state as a result of the judgment (In case of “NO” in step 145), measures to cope with the deterioration state, such as measures to display the deterioration state or to save information into another location before the medium is deteriorated, are taken in step 146. When there is no problem in the deterioration state as a result of the judgment (In case of “YES” in step 145), the voltage is applied to make reproduction in step 147. Here, the term of “between electrodes” means a set of electrodes between which the electrochromic layer is held.

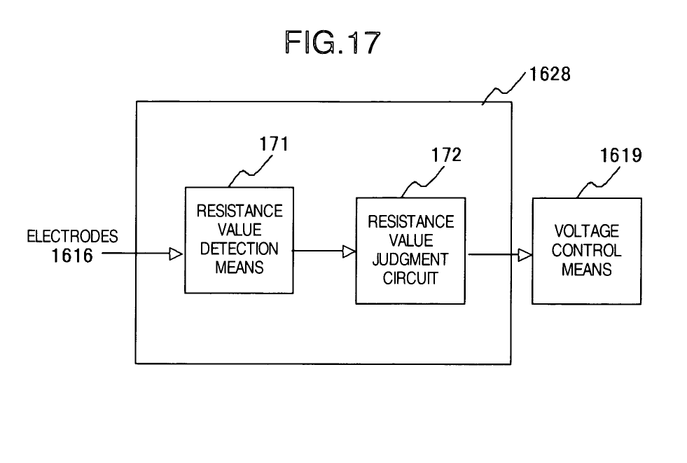

The above operation is now described with reference to the block diagram illustrating the information reproducing apparatus of FIG. 16. A medium state judgment circuit 1628 makes measurement of the resistance value and judgment of the deterioration state through the electrodes 1616. The medium state judgment circuit is illustrated in FIG. 17 in detail. In the medium state judgment circuit 1628, a resistance value detected by resistance value detection means 171 is supplied to a resistance value judgment circuit 172 and the resistance value judgment circuit 172 judges the deterioration state of the medium on the basis of a reference value and reports its judgment result to the voltage control means 1619. FIG. 10 shows the relation of the deterioration state and the resistance value between the electrodes of a plurality of media. A high voltage is applied to the media to deteriorate those by way of example. According to this method, the number of voltage applications at which the medium is deteriorated is different depending on the medium, while the resistance value and the deterioration state are correlated with each other and there is a tendency that the medium is suddenly deteriorated after the resistance becomes smaller than a reference value RE (for example 100Ω). Accordingly, it is judged that the medium is about to fall in the deterioration state at the time that the resistance value becomes smaller than the reference value, so that there can be taken measures to report the deterioration state to the host apparatus 1620 to display the deterioration state before the medium is deteriorated completely or to save information into another location before the medium is deteriorated. Further, it can be prevented that information is recorded in a layer or medium which is about to fall in the deterioration state and valuable data is destroyed. The reference resistance value RE used to make such judgment is scattered depending on a medium and it is desired that the reference value for the judgment is recorded in the reproduction apparatus. Consequently, the resistance value can be measured before application of a voltage and the judgment can be made before information recorded in the medium is read out.

As described above, in the voltage layer selection type multi-layer optical disk for making recording or reproducing by irradiation of energy, the resistance between each pair of electrodes is measured and the voltage is applied only to the layer judged that the medium is normal, so that it can be prevented that an unnecessary voltage is applied to the medium that is about to fall in the deterioration state to thereby accelerate the deterioration. Further, since the deterioration state of the medium can be detected by the judgment method before the voltage is applied, the judgment can be made in a short time.

The learning system, the structure of the medium, the material, the information recording method, the information reproducing method and the apparatuses thereof which are not described in the embodiment are the same as those of the embodiments 1 to 5.

### Embodiment 7

In the embodiment 7 of the present invention, an example of monitoring the deterioration state of the information recording medium by the learning for reproduction is described.

(Medium State Judgment System)

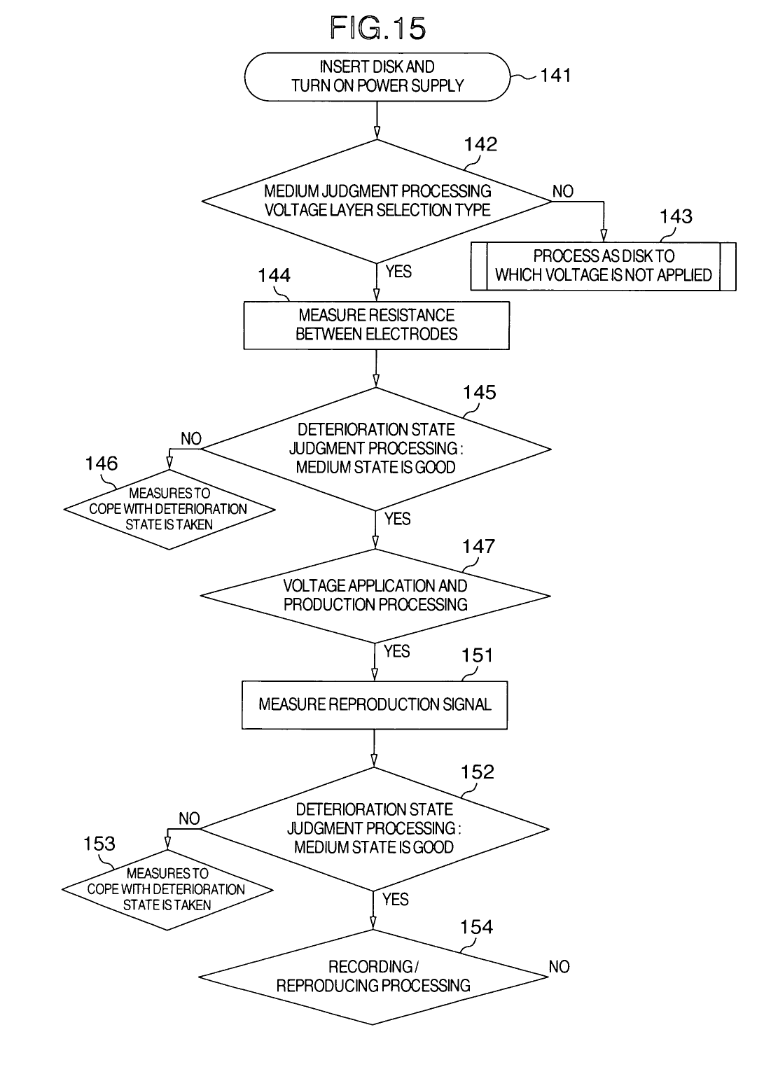

FIG. 15 shows a processing flow for detecting the state of a disk in detail after the resistance between the electrodes is used to judge the disk to be satisfactory. The processing of FIG. 15 is the same as that of FIG. 14 part of the way thereof. After there is no problem in the deterioration state as a result of the deterioration state judgment processing of step 145, the voltage application and production processing of step 147 is performed and the reproduction signal is measured (step 151). The deterioration state is judged on the basis of the measured result (step 152). When there is a problem in the deterioration state as a result of the judgment (In case of “NO” in step 142), measures to cope with the deterioration state are taken. Since data can be reproduced by the measures of step 153 in this stage, it is judged that the medium is about to fall in the deterioration state, so that measures to display the deterioration state before the medium is deteriorated completely or to save information into another location before the medium is deteriorated are taken. When there is no problem in the deterioration state as a result of the judgment (In case of “YES” in step 152), the medium is normal and recording/reproducing of information can be made stably.

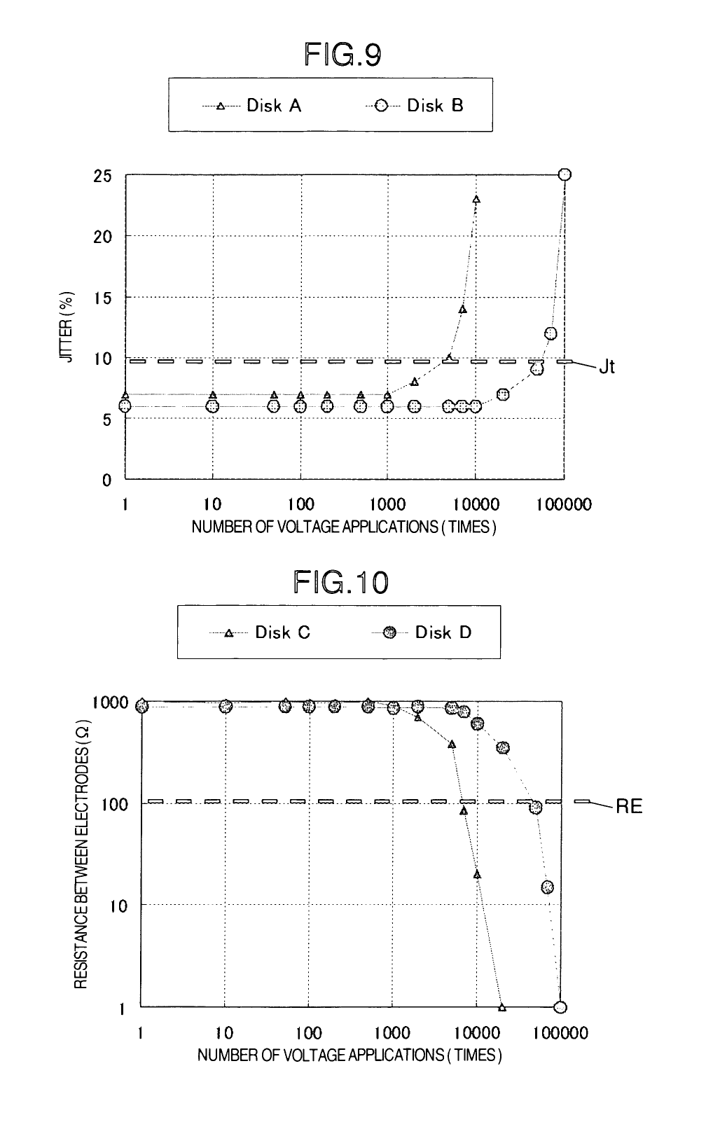

FIG. 9 shows the relation of the deterioration state and jitter in a plurality of media. In FIG. 9, a high voltage is applied to the media to deteriorate those by way of example. According to this method, the number of voltage applications at which the medium is deteriorated is different depending on the medium, while jitter and the deterioration state are correlated with each other and there is a tendency that the medium is suddenly deteriorated after the jitter becomes smaller than a reference value Jt (for example 10%). Accordingly, it is judged that the medium is about to fall in the deterioration state at the time that the jitter becomes smaller than the reference value Jt, so that there can be taken measures to display the deterioration state before the medium is deteriorated completely or to save information into another location before the medium is deteriorated. Further, it can be prevented that information is recorded in a layer or medium which is about to be deteriorated and valuable data is destroyed. The reference jitter value Jt used to make such judgment is not much scattered depending on a medium and accordingly the reference value for the judgment may be recorded in the reproduction apparatus or the medium.

The learning system, the structure of the medium, the material, the information recording method, the information reproducing method and the apparatuses thereof which are not described in the embodiment are the same as those of the embodiments 1 to 7.

The present invention discloses, for example, the following information recording/reproducing apparatuses.

An information recording/reproducing apparatus comprising:

a power supply for applying a voltage to electrode layers of any of a plurality of sets provided in a recording medium and each set having an information recording layer and the electrode layers for applying the voltage to the information recording layer;

a light source for irradiating the information recording layer of the any set of the plurality of sets with light;

means for measuring a resistance between a pair of electrodes of the any set of the plurality of sets; and

means for judging whether the medium is normal or not on the basis of the measured resistance.

An information recording/reproducing apparatus comprises:

a power supply for applying a voltage to electrode layers of any of a plurality of sets provided in a recording medium and each set having an information recording layer and the electrode layers for applying the voltage to the information recording layer;

a light source for irradiating the information recording layer of the any set of the plurality of sets with light;

means for measuring a resistance between a pair of electrodes of the any set of the plurality of sets;

means for judging whether the information recording medium of the any set is normal or not on the basis of the measured resistance; and

control means for controlling to apply the voltage to the set judged to be normal and not to apply the voltage to the set judged to be not normal.

An information recording/reproducing apparatus comprises:

a power supply for applying a voltage to electrode layers of any of a plurality of sets provided in a recording medium and each set having an information recording layer and the electrode layers for applying the voltage to the information recording layer;

a light source for irradiating the information recording layer of the any set of the plurality of sets with light;

means for measuring a resistance between a pair of electrodes of the any set of the plurality of sets;

means for judging degree of deterioration of the any set on the basis of the measured resistance; and

control means for controlling to apply the voltage to a set that is not deteriorated on the basis of judgment of the judging means.

An information recording/reproducing apparatus comprises:

a power supply for applying a voltage to electrode layers of any of a plurality of sets provided in a recording medium and each set having an information recording layer and the electrode layers for applying the voltage to the information recording layer;

a light source for irradiating the information recording layer of the any set of the plurality of sets with light;

means for obtaining a reproduced signal from the information recording layer of the any set;

means for judging degree of deterioration of the any set on the basis of a measured reproduced signal; and

control means for controlling to apply the voltage to a set that is not deteriorated on the basis of judgment of the judging means.

It should be further understood by those skilled in the art that although the foregoing description has been made on embodiments of the invention, the invention is not limited thereto and various changes and modifications may be made without departing from the spirit of the invention and the scope of the appended claims.

1. An information recording/reproducing method comprising the steps of:
applying a voltage to electrode layers in any of a plurality of sets provided in a recording medium and each set having an information recording layer and the electrode layers for applying the voltage to the information recording layer;
irradiating an energy beam to obtain a reproduced signal from the information recording layer of the any set;
adjusting the voltage applied to the electrode layers on the basis of the reproduced signal; and
recording or reproducing information in the information recording layer of the any set after the adjustment.

2. The information recording/reproducing method according to claim 1, wherein the step of adjusting the voltage adjusts at least any of level and pattern of the voltage.

3. The information recording/reproducing method according to claim 1, wherein the step of adjusting the voltage adjusts the voltage so that
the adjusted voltage is smaller than or equal to a voltage level at which signal amplitude is not deteriorated even if the voltage is applied many times.

4. The information recording/reproducing method according to claim 1, wherein the reproduced signal is a signal amplitude.

5. The information recording/reproducing method according to claim 1, wherein the reproduced signal is a level of reflectivity.

6. The information recording/reproducing method according to claim 1, wherein the step of adjusting the voltage adjusts the voltage on the basis of jitter of the reproduced signal.

7. The information recording/reproducing method according to claim 1, wherein the step of adjusting the voltage adjusts the voltage on the basis of an error rate of the reproduced signal.

8. The information recording/reproducing method according to claim 1, wherein the step of adjusting the voltage uses combination of any of a voltage level and a voltage pattern and any of a recording waveform and a recording pattern as a parameter to be adjusted.

9. An information recording/reproducing apparatus comprising:
a power supply for applying a voltage to electrode layers of any of a plurality of sets provided in a recording medium and each set having an information recording layer and the electrode layers for applying the voltage to the information recording layer;
a voltage controller for varying the voltage;
a light source for irradiating the information recording layer of the any set of the plurality of sets with light;
a detector for obtaining a reproduced signal for each of the applied voltages varied by the voltage controller;
a circuit for analyzing relation between each of the applied voltages and the reproduced signal; and
a circuit for calculating a voltage to be applied on the basis of the analyzed result and adjusting the applied voltage.
